(19) United States
(12) Patent Application Publication
(10) Pub. No.: US 2016/0255410 A1
(43) Pub. Date: Sep. 1, 2016

(54) RECOMMENDATION IMAGE DISPLAY SYSTEM, RECOMMENDATION IMAGE OUTPUT DEVICE, AND RECOMMENDATION IMAGE OUTPUT METHOD

(71) Applicant: PANASONIC INTELLECTUAL PROPERTY MANAGEMENT CO., LTD., Osaka-shi, Osaka (JP)

(72) Inventors: Tomoaki ITOH, Tokyo (JP); Mitsuhiro KAGEYAMA, Kanagawa (JP); Chikara FUKUDA, Tokyo (JP); Yoshiyuki OKIMOTO, Nara (JP)

(73) Assignee: Panasonic Intellectual Property Management Co., Lt, Osaka (JP)

(21) Appl. No.: 14/762,970

(22) PCT Filed: Oct. 20, 2014
(86) PCT No.: PCT/JP2014/005303

§ 371 Date: Jul. 23, 2015

(30) Foreign Application Priority Data
Mar. 11, 2014 (JP) 2014-048018

(51) Int. Cl. H04N 21/482; H04N 21/431; H04N 21/258; H04N 21/84; H04N 21/442; H04N 21/45

(52) U.S. Cl. CPC H04N 21/4826; H04N 21/44222; H04N 21/4532; H04N 21/25891; H04N 21/84; H04N 21/4312

(57) ABSTRACT

A recommendation image display system includes: a receiving unit which receives content related information items each of which includes a content recommendation level determined based on a content viewing history of a content item obtained from a corresponding one of a plurality of terminals; a generating unit which generates a recommendation image in which a plurality of icons for allowing a user to select one of content items are displayed based on the received content related information; and a display unit which displays the recommendation image. The plurality of icons include a first icon and a second icon indicating a content item having a recommendation level higher than that of the content item indicated by the first icon. The generating unit generates the recommendation image in which the second icon is displayed in the mode in which the second icon is more likely to be selected by the user than the first icon.

### TECHNICAL FIELD

The present disclosure relates to a recommendation image display system for providing content items that match users' tastes based on content viewing histories.

### BACKGROUND ART

In recent years, with development in information communication technology, users can view various content items through broadcasting and the Internet.

Patent Literature 1 discloses a service providing device which collects the results of evaluation on programs by general viewers and viewing tendencies and profiles of the viewers who made the evaluation, and selects and provides programs that match the tastes of particular one(s) of the viewers.

On the other hand, a user (viewer) may select a desired content item while viewing an image in which icons (such as thumbnails) indicating the details of content items are displayed.

### CITATION LIST

### Patent Literature

### [PTL 1]

International Publication No. 2005/107258

### SUMMARY OF INVENTION

### Technical Problem

The present disclosure provides a recommendation image display system etc, capable of increasing the possibility that a user selects a content item matching the user's taste.

### Solution to Problem

A recommendation image display system according to the present disclosure includes: a server which transmits a content related information item for displaying content items, the content related information item including recommendation levels of the content items and being defined based on a content viewing history obtained from each of a plurality of terminals; a receiving unit configured to receive the content related information item transmitted by the server; a generating unit configured to generate a recommendation image in which a plurality of icons for allowing a user to select one of content items are displayed, based on the content related information item received; and a display unit configured to display the recommendation image, wherein the plurality of icons include a first icon and a second icon, the second icon indicating a content item having a recommendation level higher than a recommendation level of a content item indicated by the first icon, and the generating unit is configured to generate the recommendation image which is a recommendation image in which the second icon is displayed in a mode in which the second icon is more likely to be selected by the user than the first icon.

### Advantageous Effects of Invention

According to the recommendation image display system disclosed herein, it is possible to increase the possibility that the user selects a content item matching the user's taste.

### BRIEF DESCRIPTION OF DRAWINGS

FIG. 1 is a block diagram indicating an outline of a recommendation image display system according to Embodiment 1.

FIG. 2 is a schematic diagram indicating an example of display modes of icons.

FIG. 3 is a block diagram indicating a configuration of a recommendation image display system.

FIG. 4 is a diagram indicating a method for generating a recommendation list.

FIG. 5 is a diagram indicating a method for determining recommendation levels.

FIG. 6 is a diagram indicating an example of a generated recommendation list.

FIG. 7 is a flowchart of a method for generating a recommendation image.

FIG. 8 is a flowchart of a method for generating a recommendation image in which each of thumbnails which indicates a content item having a high recommendation level is displayed in the form of a video.

FIG. 9 is a first diagram indicating the outline of a method for increasing an appearance frequency of each of thumbnails which has a high recommendation level.

FIG. 10 is a second diagram indicating the outline of a method for increasing an appearance frequency of each of thumbnails which has a high recommendation level.

FIG. 11 is a flowchart of a method for generating a recommendation image in which the appearance frequency of each of thumbnails which has a high recommendation level is increased.

FIG. 12 is a block diagram indicating a configuration of a recommendation image display system according to Variation 1.

FIG. 13 is a diagram indicating a method for generating a recommendation list according to Variation 1.

FIG. 14 is a block diagram indicating a configuration of a recommendation image display system according to Variation 2.

FIG. 15 is a diagram indicating a specific example of a receiving device.

### DESCRIPTION OF EMBODIMENTS

Hereinafter, embodiments are described in detail referring to the drawings as appropriate. It is to be noted that unnecessarily detailed descriptions thereof may be omitted. For example, already well-known matters and descriptions of substantially the same elements may be omitted. This is done in order to prevent the following descriptions from being redundant unnecessarily and allow those skilled in the art to easily appreciate the present disclosure.

The inventors provide the attached drawings and the descriptions below so that those skilled in the art can fully appreciate the present disclosure. Therefore, the subject matter defined in the claims is not intended to be restricted based on the drawings and the descriptions.

### Embodiment 1

### [Outline]

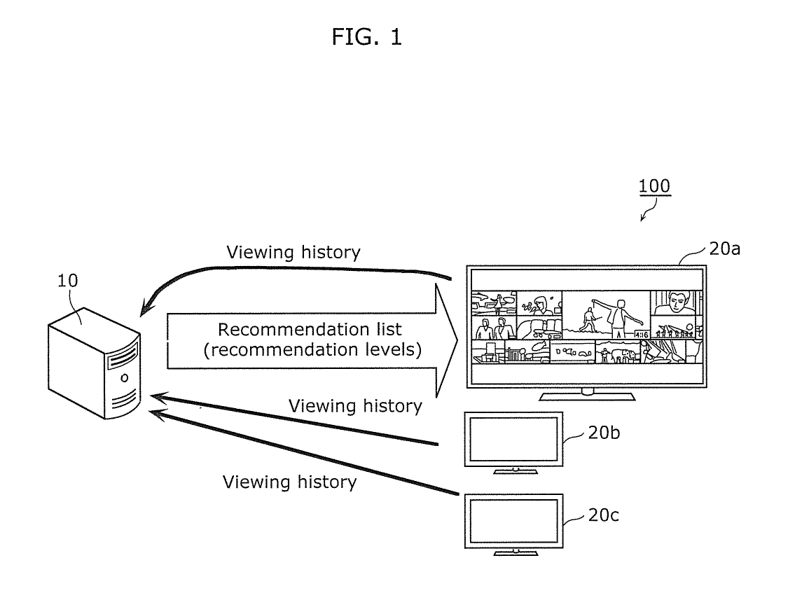

First, the outline of a recommendation image display system according to Embodiment 1 is described with reference to FIG. 1. FIG. 1 is a block diagram indicating the outline of the recommendation image display system according to Embodiment 1.

The recommendation image display system 100 is mainly composed of a server 10, a plurality of receiving terminals (communication terminals) 20a to 20c.

The server 10 obtains a content viewing history from each of the plurality of receiving terminals 20a, 20b, and 20c, and generates a recommendation list based on the obtained content viewing history. Here, the recommendation list is an example of a content related information item which is for displaying a content item and is composed mainly of meta information (such as the title of the content item, the URL, etc.). In Embodiment 1, the recommendation list is different for each receiving terminal. In the example of FIG. 1, a recommendation list for the receiving terminal 20a is generated.

In the recommendation image display system 100, a first feature is that the recommendation list includes the recommendation levels of the content items. The recommendation levels are evaluation values which are higher for content items having a high possibility of matching the user's taste.

The recommendation list generated in the server 10 is transmitted to the receiving terminal 20a. The receiving terminal 20a is typically a device including a display unit, and displays a recommendation image which is an image for allowing the user to select a content item according to the recommendation list. The recommendation image is an image in which a plurality of icons are displayed.

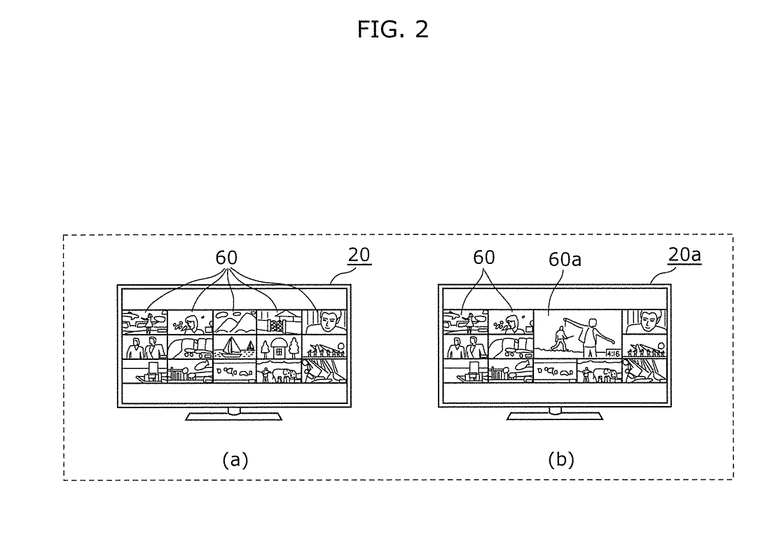

Here, in the recommendation image display system 100, a second feature is that the receiving terminal 20a modifies the display modes of the icons according to the recommendation list. FIG. 2 is a schematic diagram indicating examples of the display modes of the icons.

In a conventional receiving terminal 20 illustrated in (a) of FIG. 2, the sizes of the icons 60 each indicating a content item to be recommended for the user are equal to each other. On the other hand, in the receiving terminal 20a, as illustrated in (b) of FIG. 2, an icon 60a (a second icon) indicating a content item having a recommendation level higher than those of icons 60 (first icons) is displayed larger than the icons 60. Stated differently, one feature is that the display modes of the icons are modified according to the recommendation levels of the content items.

### [Configuration]

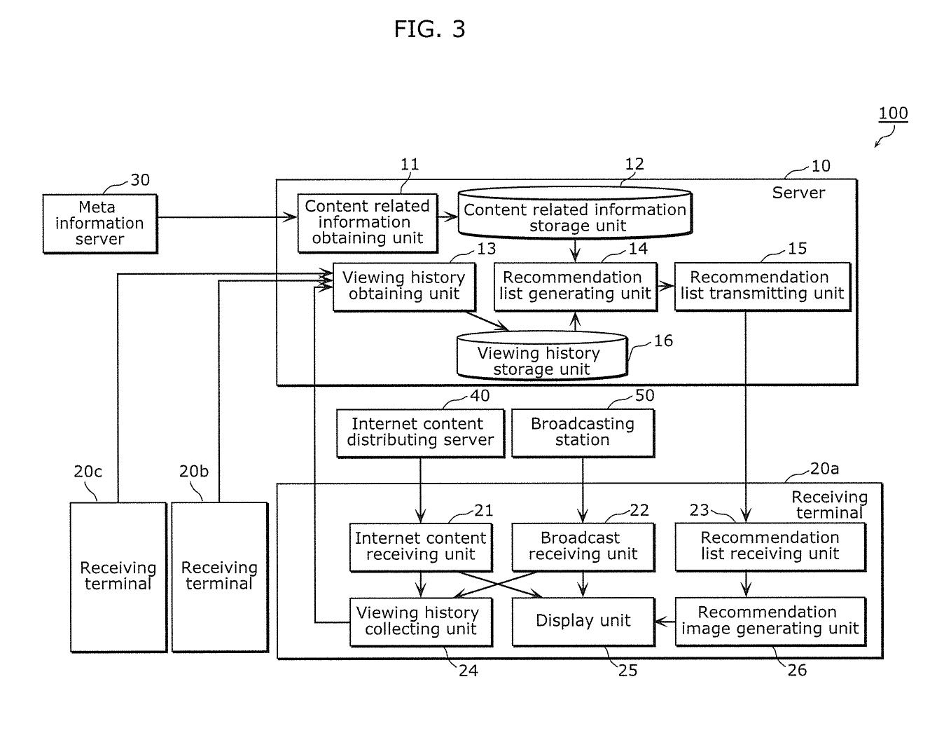

Next, a configuration of the recommendation image display system 100 is described. FIG. 3 is a block diagram indicating the configuration of the recommendation image display system.

As illustrated in FIG. 3, the recommendation image display system 100 includes: a server 10; receiving terminals 20a, 20b, and 20c; a meta information server 30; an internet content distributing server 40; and a broadcasting station 50.

First, the server 10 is described. The sever 10 performs communication with the meta information server 30 and the receiving terminals 20a, 20b, and 20c, and generates the above-described recommendation list.

The sever 10 includes: a content related information obtaining unit 11; a content related information storage unit 12; a viewing history obtaining unit 13; a recommendation list generating unit 14; a recommendation list transmitting unit 15; and a viewing history storage unit 16.

The content related information obtaining unit 11 obtains content related information items which are meta information items of content items from the meta information server 30, and stores the content related information items in the content related information storage unit 12.

The content related information storage unit 12 is a storage unit in which the content related information items obtained by the content related information obtaining unit 11 are stored. The content related information storage unit 12 is specifically a recording medium that is, for example, a semiconductor memory such as a FLASH memory, a ferroelectric substance memory, and an HDD (hard disc drive).

The viewing history obtaining unit 13 obtains the content viewing history from each of the terminals (receiving terminals 20a, 20b, and 20c) via a communication network. In addition, the viewing history obtaining unit 13 stores the obtained content viewing history to the viewing history storage unit 16.

The viewing history storage unit 16 is a storage unit in which the content viewing history obtained by the viewing history obtaining unit 13 is stored. The viewing history storage unit 16 is specifically a recording medium that is, for example, a semiconductor memory such as a FLASH memory, a ferroelectric substance memory, and an HDD.

The recommendation list generating unit 14 determines the recommendation levels of the content items based on the content viewing history of the content items (obtained by the viewing history obtaining unit 13 and) stored in the viewing history storage unit 16, and generates recommendation lists which are content related information items including the determined recommendation levels. The method for determining the recommendation levels by the recommendation list generating unit 14 are described in detail later. It is to be noted that the generated recommendation lists may be stored in a storage unit in the server 10.

The recommendation list transmitting unit 15 is a communication unit which transmits the recommendation lists generated by the recommendation list generating unit 14 to the receiving terminal 20a via the communication network. The recommendation list transmitting unit 15 is specifically a general communication module or the like. It is to be noted that the recommendation list transmitting unit 15 may transmit the recommendation lists stored in the storage unit in the server 10.

Next, the receiving terminal 20a is described. The receiving terminals 20b and 20c have the same configuration as the receiving terminal 20a, and thus the same descriptions thereof are not repeated.

The receiving terminal 20a is a device with which the user views content items, and which is a television receiver (image display device) in this example, but may be any other information communication terminal that is, for example, a smartphone, a tablet terminal, or a PC. The receiving terminal 20a includes: an Internet content receiving unit 21; a broadcast receiving unit 22; a recommendation list receiving unit (receiving unit) 23; a viewing history collecting unit 24; a display unit 25; and a recommendation image generating unit (generating unit) 26.

The Internet content receiving unit 21 receives a content item from the Internet content distributing server 40 via the communication network. The content item (hereinafter also referred to as an Internet content item) received from the internet content receiving unit 21 is, for example, an internet video (or a still image).

The broadcast receiving unit 22 receives a content item from a broadcasting station 50 via a broadcast wave (a broadcast signal). The broadcast receiving unit 22 is specifically a communication unit including a tuner, and obtains the content item via the broadcast wave. The content item (hereinafter also referred to as a broadcast content item) received by the broadcast receiving unit 22 is, for example, a television program.

The recommendation list receiving unit 23 receives a recommendation list from the server 10 (recommendation list transmitting unit 15) via the communication network. The recommendation list receiving unit 23 is specifically a general communication module or the like.

The viewing history collecting unit 24 collects a meta information item of the content item (for example, the title of the content item) received through the internet content receiving unit 21 or the broadcast receiving unit 22 and displayed on the display unit 25 as a content viewing history in the receiving terminal 20a. The collected content viewing history is transmitted to the server 10 (viewing history obtaining unit 13). It is to be noted that the content viewing history may be stored in the storage unit in the receiving terminal 20a.

The recommendation image generating unit 26 generates a recommendation image in which a plurality of icons for allowing the user to select a content item are displayed based on the recommendation list received by the recommendation list receiving unit 23. Stated differently, the recommendation image is a screen for content selection. In Embodiment 1, thumbnails are displayed as examples of icons in the recommendation image. The displayed thumbnails are reduced-size versions of images included in (or related to) content items, such as scenes of the content items.

The display unit 25 displays the recommendation image and the content item selected via the recommendation image. The display unit 25 is, for example, a liquid crystal panel or an organic EL (electro luminescence panel). When the receiving terminal 20a is a smartphone, or the like, touch panels are combined on the display unit 25, and the display unit 25 also functions as an input receiving unit (an input interface) which receives an input from the user.

The meta information server 30 is a server which distributes meta information items of the content items.

The internet content distributing server 40 is a server which distributes internet content items via the communication network such as the Internet.

The broadcasting station 50 distributes the broadcast content items by transmitting the broadcast waves.

### [Method for Generating Recommendation Lists]

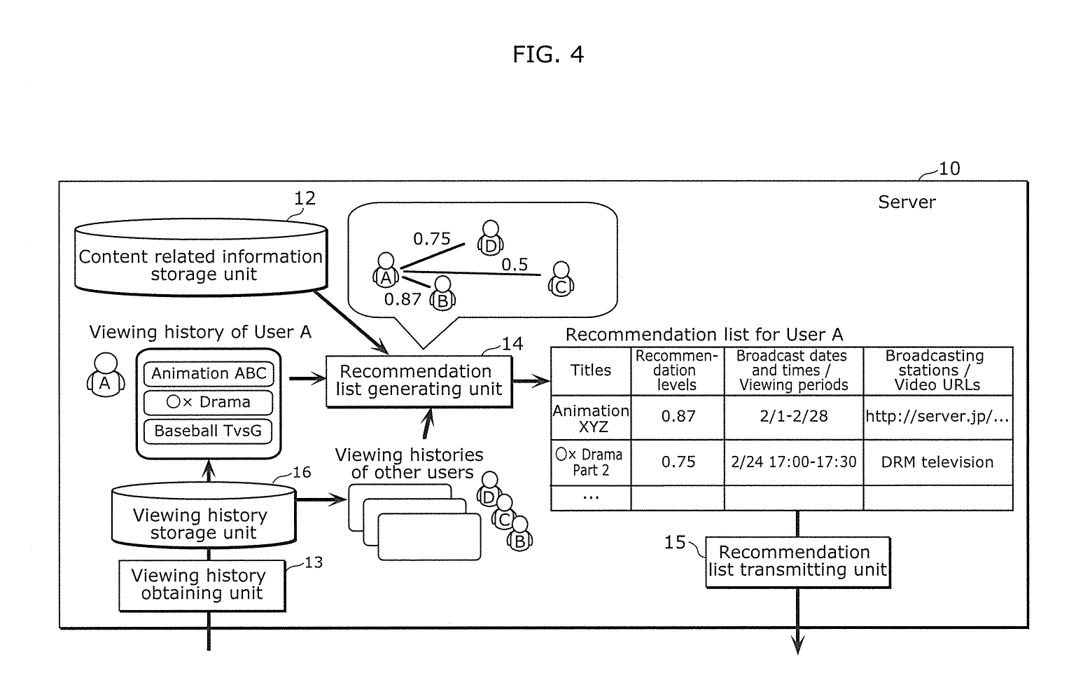

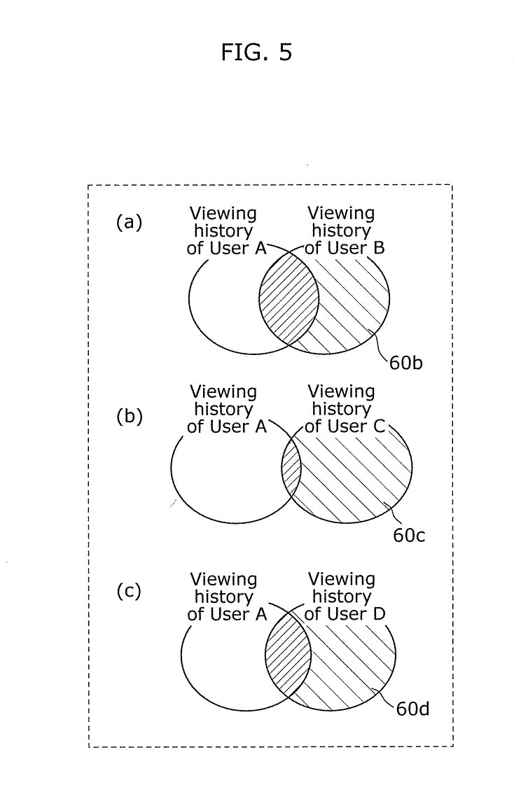

Next, a method for generating a recommendation list and a method for determining recommendation levels by the recommendation list generating unit 14 are described with reference to FIGS. 4 and 5. FIG. 4 is a diagram indicating the method for generating the recommendation list. FIG. 5 is a diagram indicating the method for determining the recommendation levels. FIG. 4 is a diagram illustrating an example of generating the recommendation list for User A who is the user of the receiving terminal 20a.

As illustrated in FIG. 4, the content viewing histories obtained by the viewing history obtaining unit 13 are stored in the viewing history storage unit 16. The recommendation list generating unit 14 obtains the content viewing history of User A and the content viewing histories of the other users (Users B, C, and D) from the viewing history storage unit 16. The recommendation list generating unit 14 determines the recommendation levels of the content items based on the content viewing histories. The recommendation levels are represented as evaluation values which are numerical values ranging from 0 to 1. A higher evaluation value indicates a higher match with the taste of User A.

As for each of the content viewing histories of the other users, it is considered that a higher percentage of content items included in one of the content viewing histories of the other users and viewed by User A (content items also included in the content viewing history of User A) indicates a higher match between the taste of the user of the one of the content viewing histories and User A. Accordingly, content items included in the one of the content viewing histories having the high percentage of content items viewed by User A but have not yet been viewed by User A (content items which are not included in the content viewing history of User A) are considered to be content items having a high possibility of a match with the taste of User A.

The recommendation list generating unit 14 compares the content viewing histories, and determines recommendation levels for each content viewing history according to the percentage of the viewed content items. Specifically, the recommendation list generating unit 14 assigns a higher recommendation level to an unviewed content item included in a content viewing history having a higher percentage of viewed content items.

More specifically, as illustrated in (a) to (c) in FIG. 5, the percentages of the viewed content items in the content viewing histories of the other users are presented as the following expression: the content viewing history of User B>the content viewing history of User D>the content viewing history of User C. Accordingly, the recommendation levels are presented as the following expression: the unviewed content item 60b included in the content viewing history of User B>the unviewed content item 60d included in the content viewing history of User D>the unviewed content item 60c included in the content viewing history of User C. In the examples of FIGS. 4 and 5, the recommendation level of the unviewed content item 60b is 0.87, the recommendation level of the unviewed content item 60c is 0.5, and the recommendation level of the unviewed content item 60d is 0.75.

On the other hand, as illustrated in FIG. 4, the recommendation list generating unit 14 obtains a content related information item that is a target to be added to the recommendation list from the content related information storage unit 12. The content related information item includes the title of the content item, a broadcast date and time, a viewable period, etc. It is to be noted that the content item that is the target to be added to the recommendation list is, for example, a content item having a recommendation level higher than a predetermined value in the unviewed content items, and may be selected in any way.

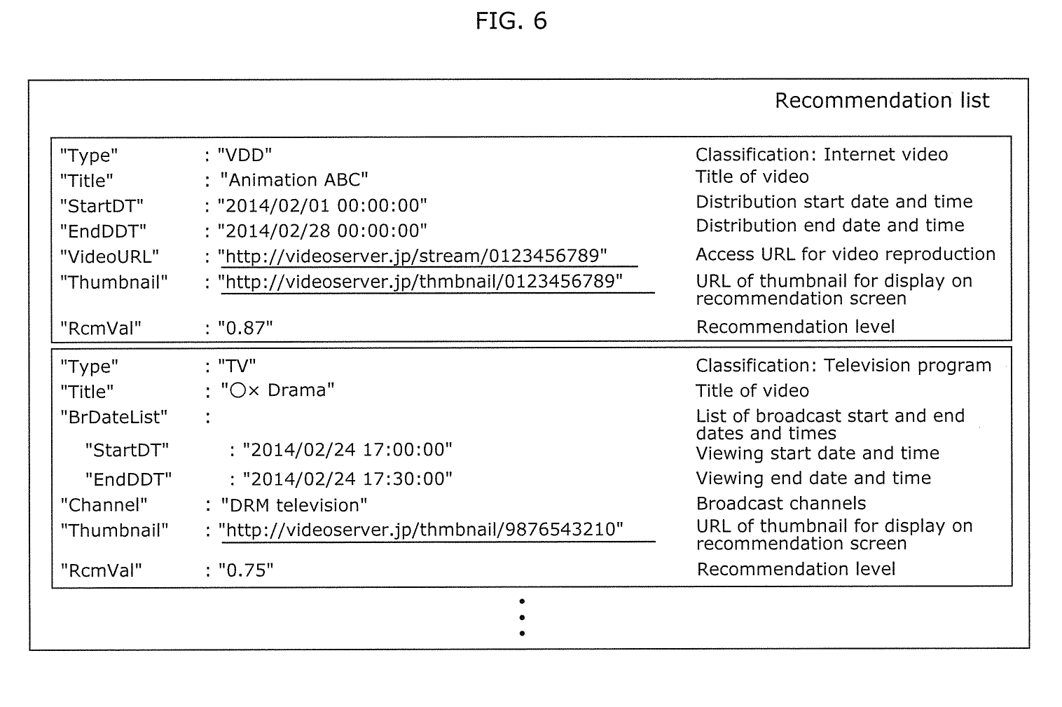

The recommendation list generating unit 14 generates a recommendation list by adding the recommendation level determined as described above to the obtained content related information item. The generated recommendation list is transmitted to the receiving terminal 20a by the recommendation list transmitting unit 15. FIG. 6 is a diagram indicating an example of the generated recommendation list.

As illustrated in FIG. 6, when the content item that is a target to be recommended is an internet content item, the classification of the content item, the title of the content item, the distribution start and end dates and times are recorded in the recommendation list, as the content related information item (hereinafter also referred to as one or more entries) of the content item that is the target to be recommended. An entry indicating that a content item is an internet content item also includes the access URL that is the address of the internet content distributing server 40 for receiving the internet content item or the URL for receiving a thumbnail to be displayed in the recommendation image.

In the case where a content item as a target to be recommended is a broadcast content item, the classification of the content item, the title of the content item, a list of the broadcast start and end dates and times (a broadcast start date and time, and a broadcast end date and time) are recorded in the recommendation list. An entry indicating that a content item is a broadcast content item and also includes a broadcasting channel and the URL of the internet content distributing server 40 for receiving the thumbnail to be displayed in the recommendation image.

In either case, the entry is assigned with the recommendation level determined in the above described manner.

As described above, by means of the recommendation list with the recommendation levels being transmitted to the receiving terminal 20a, the receiving terminal 20a side can modify the display modes of the thumbnails according to the recommendation levels.

In each of the above examples, the recommendation levels are determined for each content viewing history. However, high and low recommendation levels may be set within the same content viewing history. For example, the recommendation list generating unit 14 may assign a weighting coefficient for each genre of a content item within the same content viewing history, and may integrate the weighting coefficient with the recommendation level according to the genre.

### [Method for Generating Recommendation Image]

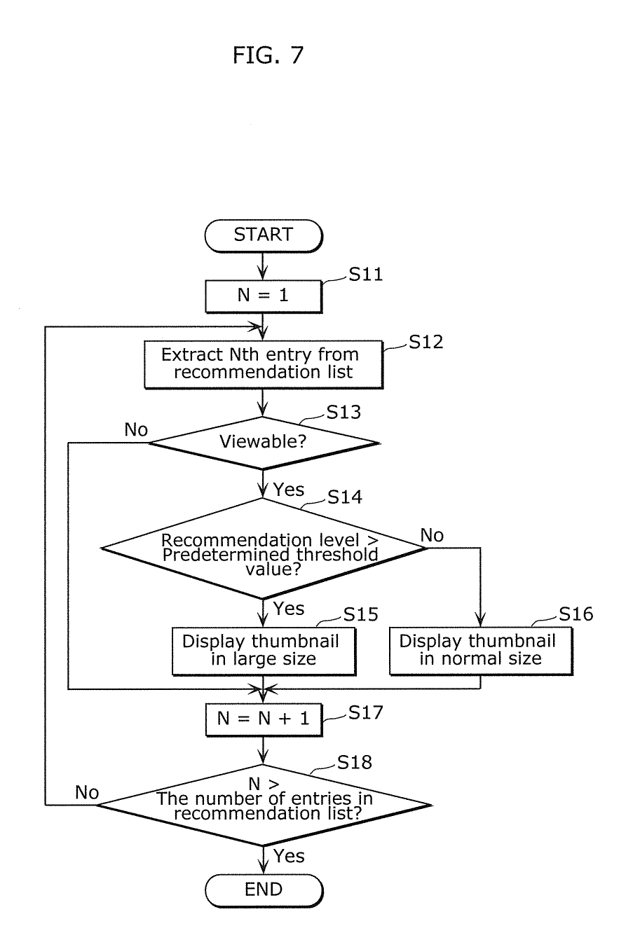

Next, a method for generating a recommendation image in the receiving terminal 20a is described with reference to FIG. 7. FIG. 7 is a flowchart of the method for generating the recommendation image.

In the example of FIG. 7, the recommendation image generating unit 26 generates a recommendation image in which thumbnails (a second icon group) each indicating a content item having a recommendation level higher than a predetermined threshold value are displayed larger than thumbnails (a first icon group) each indicating a content item having a recommendation level lower than or equal to the predetermined threshold value. As a result, the display unit 25 displays the recommendation image as illustrated in (b) of FIG. 2.

The processes in the flowchart of FIG. 7 are started assuming that N=1 (S11). The recommendation image generating unit 26 extracts an Nth entry from the recommendation list (S12). Next, whether the extracted entry is viewable is determined (S13). It is to be noted that whether the content item indicated by the extracted entry is viewable is determined referring to the distribution start and end dates and times (broadcast start and end dates and times) of the extracted entry and a current date and time.

In the example of FIG. 7, only the thumbnails indicating the viewable content items are displayed. However, thumbnails indicating unviewable content items may be displayed. For example, thumbnails indicating content items (programs) that have currently been unviewable but will be viewable in the future may be displayed. When these thumbnails are selected by the user, it is also possible to make a transition to a viewing reservation screen or a recording reservation screen, or guide to a preview video of the content item that is identified by the selected thumbnail.

When the content item indicated by the extracted entry is viewable (Yes in S13), the recommendation image generating unit 26 determines whether the recommendation level included in the entry is higher than the predetermined threshold value (S14).

When the recommendation level is higher than the predetermined threshold value (Yes in S14), the thumbnail indicated by the entry is displayed in a size (for example, the double size with respect to the normal size) larger than the normal size in the recommendation screen (S15). On the other hand, when the recommendation level is lower than the predetermined threshold value (No in S14), the thumbnail indicated by the entry is displayed in the normal size in the recommendation screen (S16). It is to be noted that the information for displaying the thumbnail is obtained from the internet content distributing server 40, based on the URL of the thumbnail included in the entry.

Next, the number N of the entry is incremented (S17), and until the number N exceeds the number of entries included in the recommendation list (Yes in S18), the processes of Steps S12 to S17 are repeated (No in S18). When the content item is determined to be unviewable in Step S13 (No in S13), the number N of the entry is also incremented (S17), and the processing is continued.

In this way, the recommendation image generating unit 26 generates a recommendation image in which a thumbnail (a second icon) indicating a content item having a high recommendation level is displayed larger than thumbnails (first icons) indicating content items each having a low recommendation level.

By the thumbnail that indicates the content item with the high recommendation level being displayed in the large size, the thumbnail are more likely to be perceived by the user than the thumbnails that indicate the content items with low recommendation levels. Stated differently, the content item with the high recommendation level draws the user's attention more significantly than the content items with the low recommendation levels do, and thus is likely to be selected by the user (has an increased possibility of being selected by the user).

In the receiving terminal 20a, the following cases are conceivable: a case where a content item is selected by placing a pointer on a thumbnail (for example, in the case of using a PC or the like), and a case where a content item is selected by making an input in a detection range corresponding to the size of the thumbnail on a touch panel (for example, in the case of using a smartphone). In this case, by means of the thumbnail being displayed in a large size, the thumbnail is physically likely to be selected by the user. Here, “the thumbnail is physically likely to be selected by the user” means, for example, that the possibility that the thumbnail is selected is increased even when the user touches the display unit 25 at random.

As described above, according to the recommendation image display system 100, it is possible to increase the possibility that the user selects a content item matching the user's taste.

In the above-described example, the high and low recommendation levels are determined based on the threshold value. However, the high and low recommendation levels may be determined in any manner. For example, the recommendation image generating unit 26 may generate a recommendation image in which a predetermined number of thumbnails (a second icon group) are displayed in the modes in which the thumbnails are more likely to be selected by the user than the other thumbnails (a first icon group), according to the descending order of the recommendation levels of the content items indicated by the thumbnails (the second icon group). When the number of thumbnails whose display modes are modified is determined in advance in this way, the display modes can be modified without being restricted by (the design of) a decoder, etc. so much. This is an advantageous effect.

### [Variation of Method for Generating Recommendation Image]

The modes of content items displayed in a recommendation image that is generated by the recommendation image generating unit 26 is not limited to the above-described modes. It is only necessary that a content item having a higher recommendation level be displayed in a mode in which the content item is more likely to be selected by a user than a content item having a lower recommendation level.

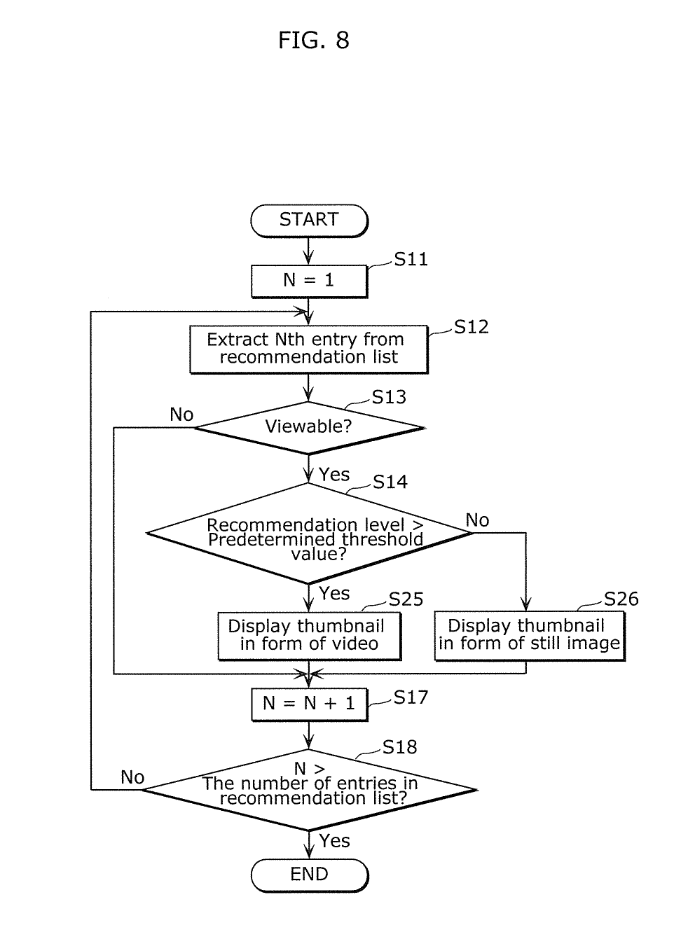

For example, the recommendation image generating unit 26 may generate a recommendation image in which a thumbnail (a second icon) indicating a content item having a high recommendation level is displayed in the form of a video, and a thumbnail (a first icon) indicating a content item having a low recommendation level is displayed in the form of a still image. FIG. 8 is a flowchart of a method for generating a recommendation image in which a thumbnail indicating a content item having a high recommendation level is displayed in the form of a video. The flowchart in FIG. 8 is obtained by replacing Steps S15 and S16 in the flowchart of FIG. 7 with Steps S25 and S26. Thus, the same descriptions are not repeated.

As illustrated in FIG. 8, when the recommendation level is higher than a threshold value (Yes in S14), the thumbnail of the content item indicated by a current entry is displayed in the form of a video (S25). At this time, when the content item is a broadcast content item, video information for displaying the thumbnail in the form of the video is obtained from the broadcasting station 50, and when the content item is an internet content item, video information for displaying the thumbnail in the form of the video is obtained from the internet content distributing server 40.

When the recommendation level is lower than or equal to the threshold value (No in S14), the thumbnail of the content item indicated by the entry is displayed in the form of a still image (S26). The other processes are the same as in the flowchart of FIG. 7.

In this way, by the thumbnail indicating the content item having the higher recommendation level is displayed in the form of the video, the thumbnail is more likely to be perceived by the user than the thumbnail indicating the content item having the lower recommendation level (the thumbnail displayed in the form of the still image). In other words, according to the recommendation image, it is possible to increase the possibility that the user selects a content item matching the user's taste.

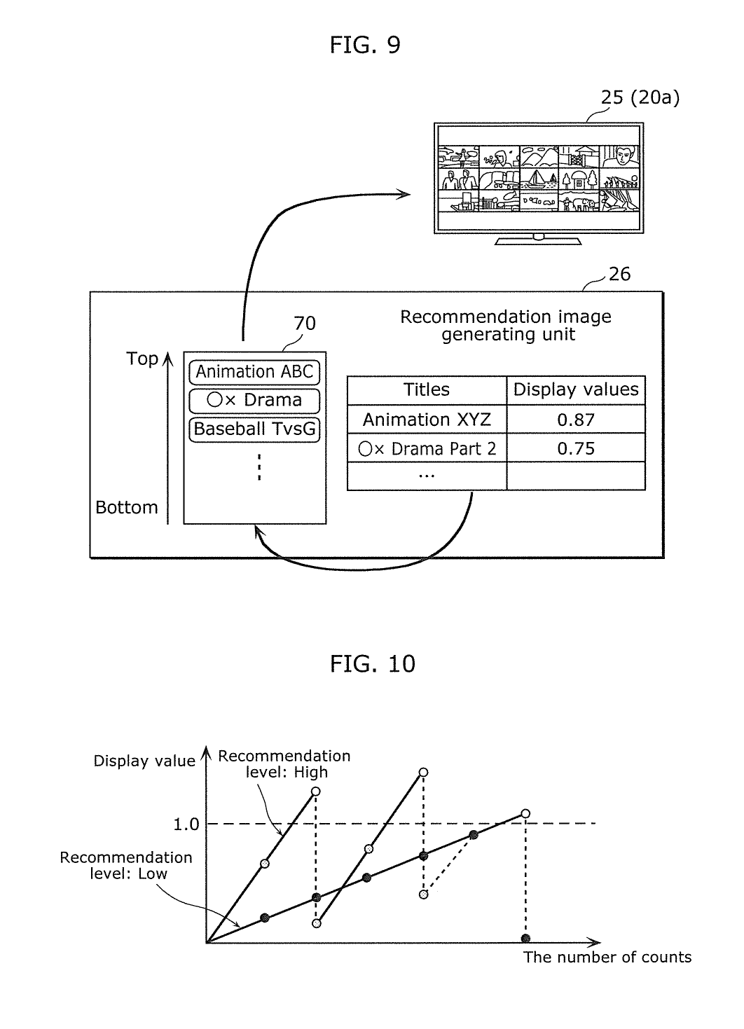

Furthermore, when thumbnails displayed on the display unit 25 are changed (updated) as time passes or other reasons, the recommendation image generating unit 26 may generate a recommendation image in which a thumbnail indicating a content item having a higher recommendation level appears more frequently than a thumbnail indicating a content item having a lower recommendation level. FIGS. 9 and 10 each is a diagram indicating the outline of a method for increasing the appearance frequency of each thumbnail having a high recommendation level.

In the configuration illustrated in FIG. 9, the display unit 25 displays a recommendation image in which a predetermined number of thumbnails are included. It is assumed here that the thumbnails included in the recommendation image are sequentially replaced with the thumbnail placed at the top in a display waiting cue 70 as a predetermined time passes.

In this configuration, a method for changing a placement frequency to the display waiting cue 70 based on a recommendation level (display value) of a content item having a high recommendation level is conceivable as a method for increasing the appearance frequency of the thumbnail indicating the content item. More specifically, for example, a method illustrated in FIG. 10 is conceivable.

As illustrated in FIG. 10, each thumbnail (corresponding to each entry) has, as a unit display value, the recommendation level of the content item indicated by the thumbnail, and the thumbnail is added to the end of the display waiting cue 70 according to a display value whose initial value is the unit display value.

More specifically, the unit display value of the thumbnail is added to the display value of the thumbnail for every predetermined period (so as to be updated). The thumbnail whose display value reaches or exceeds 1 (predetermined value) is added to the end of the display waiting cue 70, and the display value is reset (a reset process for decrementing the display value by 1 is performed). In this way, a thumbnail indicating a content item having a higher recommendation level is placed in the display waiting cue 70 more frequently.

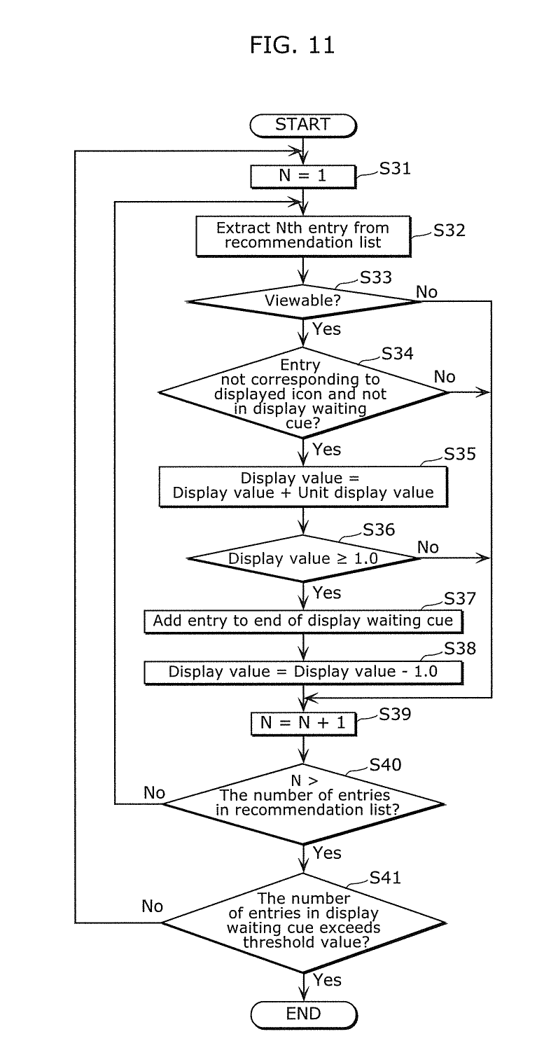

The above-described processes are described in detail with reference to a flowchart. FIG. 11 is the flowchart of a method for generating a recommendation image in which the appearance frequency of each thumbnail having the high recommendation level is increased. It is to be noted that descriptions of substantially the same steps as in the flowchart of FIG. 7 may not be repeated below.

The processes in the flowchart of FIG. 11 are started assuming that N=1 (S31). The recommendation image generating unit 26 extracts an Nth entry from the recommendation list (S32). Next, the recommendation image generating unit 26 determines whether the extracted entry is viewable (S33).

When the content item indicated by the extracted entry is viewable (Yes in S33), the recommendation image generating unit 26 checks whether the entry does not correspond to an icon that is currently being displayed and does not exist in a display waiting cue 70 (S34).

When the entry is not the entry of a content item that is currently being displayed and does not exist in the display waiting cue 70 (Yes in S34), a unit display value is further added to a current display value (S35). As described above, the initial value of the display value is the unit display value itself. For example, in the case of an entry (thumbnail) having a basic display value of 0.87 and a display value of 0.87 (initial value), the display value amounts to 1.74 after addition of 0.87 in Step S35.

When the display value reaches or exceeds 1 (Yes in Step S36), the entry is added to the end of the display waiting cue 70 (S37), and the display value is decremented by 1 (S38).

Next, the number N of the entry is incremented (S39), and until the number N exceeds the number of entries included in the recommendation list (Yes in S40), the processes of Steps S32 to S39 are repeated (No in S40). When the content item is determined to be unviewable in Step S33 (No in S33), the number N of the entry is also incremented (S39), and the processing is continued. When, in Step S34, the entry is an entry corresponding to the icon that is currently being displayed or exists in the display waiting cue 70 (No in S34), the number of the entry is incremented (S39), and the processing is continued.

The above-described processes in Steps S31 to S40 are repeated (No in S41) until the number of entries in the display waiting cue exceeds the threshold value (Yes in S41).

By the thumbnail that indicates the content item with the high recommendation level being displayed frequently in this way, the thumbnail is more likely to be perceived by the user than the thumbnails that indicate the content items with low recommendation levels.

Furthermore, a case is conceivable in which a content item indicated by a thumbnail can be selected via a remote controller or a touch panel only when the thumbnail is scrolled and exists in the recommendation image. In this case, by the thumbnail with a high recommendation level appearing frequently, the probability that the user selects the thumbnail with the high recommendation level is physically increased.

When thumbnails are scrolled in the recommendation image, the recommendation image generating unit 26 may generate a recommendation image in which a thumbnail indicating a content item having a high recommendation level is scrolled more slowly than a thumbnail indicating a content item having a low recommendation level.

For example, when a thumbnail indicating a content item having a high recommendation level exists in a recommendation image, the scroll speed may be lower than the scroll speed in the case where no thumbnail indicating a content item having a high recommendation level exists in a recommendation image. For example, when an area that is scrolled and an area that is fixedly displayed coexist in a recommendation image, a thumbnail indicating a content item having a high recommendation level may be fixedly displayed and a thumbnail indicating a content item having a low recommendation level may be scrolled.

By changing the scroll speed in this way, it is also possible to allow the user to perceive the thumbnail indicating the content item having the high recommendation level and physically increase the probability that the thumbnail indicating the content item having the high recommendation level is selected.

### [Variation 1]

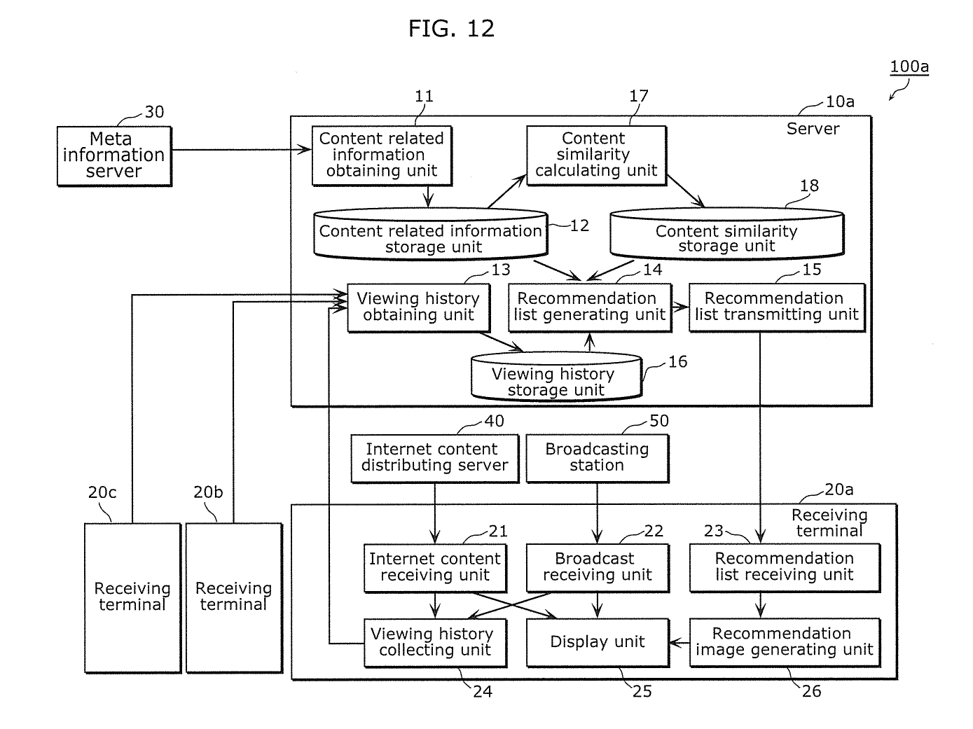

In the recommendation image display system 100, the recommendation list generating unit 14 determines the recommendation levels of content items for each of content viewing histories based on the percentages of viewed content items. However, the recommendation list generating unit 14 may determine recommendation levels according to another method. FIG. 12 is a block diagram indicating a configuration of a recommendation image display system according to Variation 1. In the descriptions below, differences (particularly, a server 10a) from the recommendation image display system 100 are focused on.

The server 10a in the recommendation image display system 100a is different from the one in the recommendation image display system 100 in the point of including a content similarity calculating unit 17 and a content similarity storage unit 18. In addition, a recommendation list generating unit 14a performs a recommendation list generating method different from the method performed by the recommendation list generating unit 14a.

The content similarity calculating unit 17 calculates similarities (content similarities) between content items. The content similarity calculating unit 17 detects keywords for the titles of the content items, compares the keywords, and calculates the content similarities. Here, in order to calculate the similarities, an existing method such as the TF-IDF (term frequency-inverse document frequency) method may be used. In addition, the content similarity calculating unit 17 stores the calculated content similarities onto the content similarity storage unit 18.

The content similarity storage unit 18 is a storage unit in which content similarities calculated by the content similarity calculating unit 17 are stored. The content similarity storage unit 18 is specifically a recording medium that is, for example, a semiconductor memory such as a FLASH memory, a ferroelectric substance memory, and an HDD.

The recommendation list generating unit 14a determines the recommendation levels of content items based on the content similarities calculated by the content similarity calculating unit 17, in addition to the content viewing histories obtained by the viewing history obtaining unit 13.

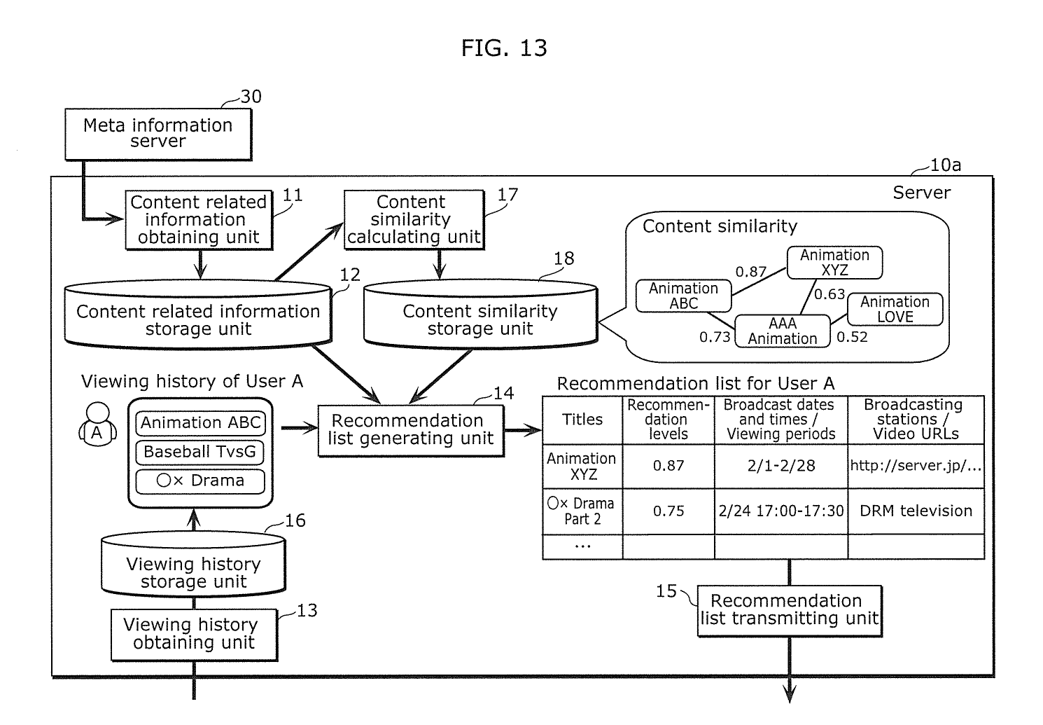

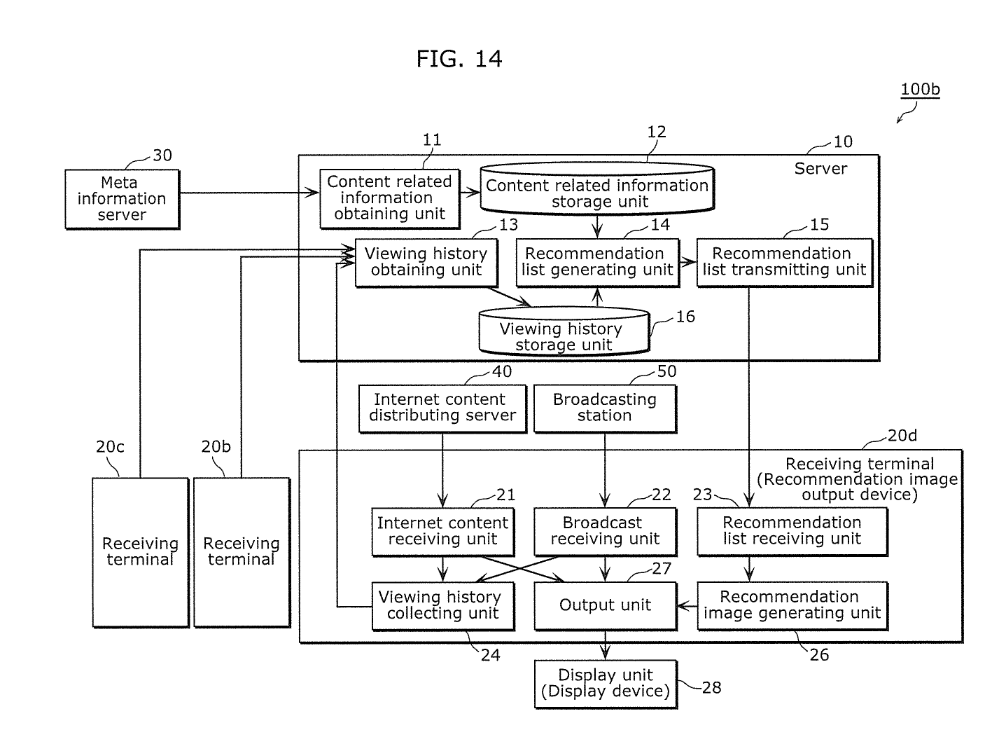

Next, a method for determining recommendation levels by the recommendation list generating unit 14a is described with reference to FIG. 13. FIG. 13 is a diagram indicating a method for generating a recommendation list according to Variation 1. FIG. 13 is a diagram illustrating an example of generating the recommendation list for User A who is the user of the receiving terminal 20a.

As illustrated in FIG. 13, the content similarity calculating unit 17 obtains content related information from the content related information storage unit 12, calculates the similarities between the titles of the content items included in the content related information, and stores the relationships in the content similarity storage unit 18 in advance.

On the other hand, the recommendation list generating unit 14a obtains the content viewing history of User A from the viewing history storage unit 16, and refers to the content similarity storage unit 18. In this way, the recommendation list generating unit 14a obtains, from the content related information storage unit 12, the content related information of the content item having a high similarity with a content item included in the content viewing history of User A.

The recommendation list generating unit 14a determines that a content item having a higher similarity (content related information) has a higher recommendation level. The recommendation list generating unit 14a generates a recommendation list in which the determined recommendation level is included in the obtained content related information.

As described above, by means of the recommendation list being transmitted to the receiving terminal 20a, the receiving terminal 20a side can modify the display modes of the thumbnails according to the recommendation levels.

Likewise the recommendation list generating unit 14, the recommendation list generating unit 14a may determine the recommendation levels of content items for each of the content viewing histories based on the percentages of viewed content items, and then further determine high and low recommendation levels in the same content viewing history based on the content similarities.

### [Variation 2]

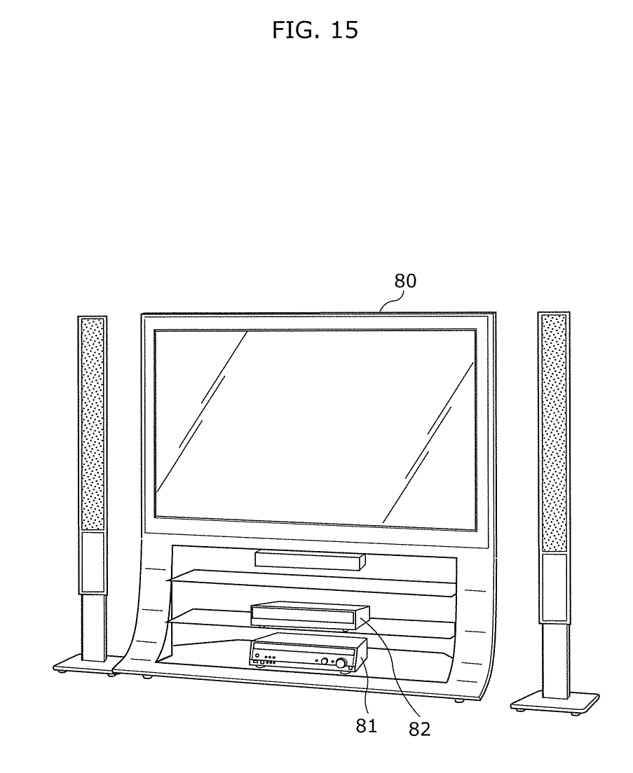

The recommendation image display system 100 and the recommendation image display system 100a each have been described as including the receiving terminal 20a and the display unit 25. However, the display unit may be configured as a unit separate from the receiving terminal 20a. FIG. 14 is a block diagram illustrating a configuration of the recommendation image display system 100b in which the display unit is provided as a unit separate from the receiving terminal 20a. In the descriptions below, differences (particularly, a receiving terminal 20d) from the recommendation image display system 100 are focused on.

In the receiving terminal 20d (recommendation image output device), an output unit 27 is provided as a replacement for the display unit 25 in the receiving terminal 20a, and the display unit 28 (display device) is provided as a separate unit.

The output unit 27 outputs a recommendation image generated by the recommendation image generating unit 26.

The display unit 28 displays the recommendation image output by the output unit 27, and content items output by the output unit 27. The display unit 25 is, for example, a liquid crystal display or an organic EL display.

In this way, an STB, Blu-Ray (registered trademark), or the like is illustrated as an example of the receiving terminal 20d that does not include any display unit, and such an implementation is also included in the present disclosure.

### Other Embodiments

As described above, Embodiment 1 has been described as an example of a technique disclosed in the present application. However, the technique disclosed herein is not limited thereto, and is applicable to other embodiments obtainable by making modification, replacement, addition, omission, etc. as appropriate. Furthermore, it is also possible to provide a new embodiment by arbitrarily combining some of the constituent elements disclosed in Embodiment 1.

In view of this, some other embodiments are described below.

In the above embodiment, icons are described as thumbnails. However, icons may be implemented in the forms indicating the contents other than the thumbnails. The content items are typically videos or still images, but may be pieces of music, advertisements, etc. which are provided through downloading or streaming.

The block diagrams described in the above embodiment are examples, and thus the constituent elements of each of the devices may be arbitrarily modified. Each of the constituent elements in the above embodiment may be configured in the form of exclusive hardware or may be implemented by executing a software program suitable for the corresponding constituent element. Each of the constituent elements may be implemented by means of a program executing unit, such as a CPU or a processor, reading and executing the software program recorded on a recording medium such as a hard disc or a semiconductor memory.

In the above embodiment, a communication network for use in the transmission and reception of information between devices is not limited to a particular one, and any one of wired or wireless communication networks may be used.

Each of the receiving terminals (communication terminals) in the recommendation image display system according to the embodiment may be implemented in any form that is, for example, the television receiver 80, a Blu-Ray (registered trademark) player 81, and a set top box 82 illustrated in FIG. 15.

General or specific aspects of the present disclosure are not limited to the system (recommendation image display system) and devices (recommendation image output devices), and may be implemented as a method (recommendation image output method). In addition, general or specific aspects of the present disclosure may be implemented in the forms of integrated circuits, computer programs, or recording media such as computer-readable CD-ROMs.

As described above, the embodiment has been described as an example of a technique according to the present disclosure. The attached drawings and detailed descriptions have been provided for illustrative purposes only.

Accordingly, in the attached drawings and detailed descriptions, constituent elements inessential to solve the problem are described as examples for illustrating the above technique, in addition to constituent elements essential to solve the problem. Therefore, the inessential constituent elements described in the attached drawings or detailed descriptions should not be directly interpreted as being essential constituent elements.

The above-described embodiment is provided to illustrate the technique according to the present disclosure. Therefore, it is possible to make various kinds of modification, replacement, addition, omission, etc. within the scope of the claims and equivalents thereof.

### INDUSTRIAL APPLICABILITY

The present disclosure is applicable to a recommendation image display system etc, capable of increasing the possibility that a user selects a content item matching the user's taste. More specifically, the present disclosure is applicable to television receivers, STBs, smartphones, tablet terminals, etc.

### REFERENCE SIGNS LIST

10, 10a Server
11 Content related information obtaining unit
12 Content related information storage unit
13 Viewing history obtaining unit
14, 14a Recommendation list generating unit
15 Recommendation list transmitting unit
16 Viewing history storage unit
17 Content similarity calculating unit
18 Content similarity storage unit
20, 20a, 20b, 20c, 20d Receiving terminal
21 Internet content receiving unit
22 Broadcast receiving unit
23 Recommendation list receiving unit (receiving unit)
24 Viewing history collecting unit
25, 28 Display unit
26 Recommendation image generating unit (generating unit)
27 Output unit
30 Meta information server
40 Internet content distributing server
50 Broadcasting station
60, 60a Icon
60b, 60c, 60d Unviewed content item
70 Display waiting cue
80 Television receiver
81 Blu-Ray (registered trademark) player
82 Set top box
100, 100a, 100b Recommendation image display system

1. A recommendation image display system comprising:
a server which transmits a content related information item for displaying content items, the content related information item including recommendation levels of the content items and being defined based on a content viewing history obtained from each of a plurality of terminals;
a receiving unit configured to receive the content related information item transmitted by the server;
a generating unit configured to generate a recommendation image in which a plurality of icons for allowing a user to select one of content items are displayed, based on the content related information item received; and
a display unit configured to display the recommendation image,
wherein the plurality of icons include a first icon and a second icon, the second icon indicating a content item having a recommendation level higher than a recommendation level of a content item indicated by the first icon, and
the generating unit is configured to generate the recommendation image which is a recommendation image in which the second icon is displayed in a mode in which the second icon is more likely to be selected by the user than the first icon.

2. The recommendation image display system according to claim 1,
wherein the generating unit is configured to generate the recommendation image which is a recommendation image in which the plurality of icons are scrolled.

3. The recommendation image display system according to claim 1,
wherein the generating unit is configured to generate the recommendation image which is a recommendation image in which the second icon appears more frequently than the first icon.

4. The recommendation image display system according to claim 1,
wherein the generating unit is configured to generate the recommendation image which is a recommendation image in which the second icon is displayed larger than the first icon.

5. The recommendation image display system according to claim 1,
wherein the generating unit is configured to generate the recommendation image which is a recommendation image in which the second icon is displayed in a form of a video and the first icon is displayed in a form of a still image.

6. The recommendation image display system according to claim 2,
wherein the generating unit is configured to generate the recommendation image which is a recommendation image in which the second icon is scrolled lower than the first icon is scrolled.

7. The recommendation image display system according to claim 1,
wherein the plurality of icons include:
a first icon group made up of one or more icons each indicating a content item having a recommendation level lower than or equal to a predetermined threshold value, the first icon group including the first icon; and
a second icon group made up of one or more icons each indicating a content item having a recommendation level higher than the predetermined threshold value, the second icon group including the first icon, and
the generating unit is configured to generate the recommendation image in which the second icon group is displayed in a mode in which the second icon group is more likely to be selected by the user than the first icon group.

8. The recommendation image display system according to claim 1,
wherein the plurality of icons include a first icon group and a second icon group,
the second icon group is made up of a predetermined number of icons which include the second icon and are selected in descending order of recommendation levels,
the first icon group is made up of one or more icons which include the first icon and do not belong to the second icon group, and
the generating unit is configured to generate the recommendation image in which the second icon group is displayed in a mode in which the second icon group is more likely to be selected by the user than the first icon group.

9. The recommendation image display system according to claim 1,
wherein the generating unit is configured to generate the recommendation image which is a recommendation image in which an icon indicating a content item having a higher recommendation level in the plurality of icons is displayed in a mode in which the icon is more likely to be selected by the user.

10. The recommendation image display system according to claim 1,
wherein the server generates and transmits the content related information item.

11. The recommendation image display system according to claim 10, further comprising
a receiving terminal including the receiving unit and the generating unit,
wherein the server further:
determines the recommendation levels of the content items based on the content viewing history obtained from each of the plurality of terminals including the receiving terminal, and generates the content related information item including the recommendation levels determined; and
assuming that, among the content items included in the content viewing histories received, (i) content items included in a content viewing history in the receiving terminal are viewed content items, and (ii) content items other than the viewed content items are unviewed content items, assigns recommendation levels to the unviewed content items in such a manner that a higher recommendation level is assigned to an unviewed content item which is included in a content viewing history having a higher percentage of the viewed content items.

12. A recommendation image output device comprising:
a receiving unit configured to receive a content related information item for displaying content items, the content related information item including recommendation levels of the content items and being defined based on a content viewing history obtained from each of a plurality of terminals;
a generating unit configured to generate a recommendation image in which a plurality of icons for allowing a user to select one of content items are displayed, based on the content related information item received; and
an output unit configured to output the recommendation image generated,
wherein the plurality of icons include a first icon and a second icon, the second icon indicating a content item having a recommendation level higher than a recommendation level of a content item indicated by the first icon, and
the generating unit is configured to generate the recommendation image which is a recommendation image in which the second icon is displayed in a mode in which the second icon is more likely to be selected by the user than the first icon.

13. The recommendation image output device according to claim 12, further comprising
a display unit configured to display the recommendation image output.

14. A recommendation image output method comprising:
receiving a content related information item for displaying content items, the content related information item including recommendation levels of the content items and being defined based on a content viewing history obtained from each of a plurality of terminals;
generating a recommendation image in which a plurality of icons for allowing a user to select a content item are displayed, based on the content related information item received; and
outputting the recommendation image generated,
wherein the plurality of icons include a first icon and a second icon, the second icon indicating a content item having a recommendation level higher than a recommendation level of a content item indicated by the first icon, and
the generating includes generating recommendation image which is a recommendation image in which the second icon is displayed in a mode in which the second icon is more likely to be selected by the user than the first icon.

15. The recommendation image output method according to claim 14, further comprising:
generating the content related information item; and
transmitting the content related information item generated,
wherein the receiving includes receiving the content related information item transmitted in the transmitting.

16. The recommendation image output method according to claim 14, further comprising
displaying the recommendation image output.

17. A non-transitory computer-readable recording medium having a program recorded thereon for causing a computer to execute the recommendation image output method according to claim 14.
